(19) United States
(12) Patent Application Publication
(10) Pub. No.: US 2018/0027515 A1
(43) Pub. Date: Jan. 25, 2018

(54) SERVER, METHOD, RECORDING MEDIUM, AND SYSTEM FOR MAINTAINING ACCURACY OF TIME

(71) Applicant: FANUC CORPORATION, Yamanashi (JP)

(72) Inventors: Masahiro TSUJI, Yamanashi (JP); Yoshito MIYAZAKI, Yamanashi (JP)

(21) Appl. No.: 15/655,006

(22) Filed: Jul. 20, 2017

(30) Foreign Application Priority Data
Jul. 22, 2016 (JP) 2016-144922

(51) Int. Cl. H04W 56/00; H04L 12/851; H04L 29/08

(52) U.S. Cl. CPC H04W 56/005; H04L 67/1095; H04L 47/24

(57) ABSTRACT

A server, method, program, recording medium, and system for maintaining accuracy of time of data without increasing frequency of synchronization processing. A synchronizing unit that executes synchronization processing at a server time T1 for synchronization between a time of a server and a time of an electronic device; a collecting unit that collects multiple n data segments and temporal data segments together from the electronic device from the time T1 to a server time T2 after the time T1, the server time T2 being a time when the synchronizing unit executes synchronization processing for synchronization between a time of the server and a time of the electronic device; and a correcting unit that corrects temporal data segments added to the n data segments based on a synchronization shift amount which is a time difference between the time T2 and temporal data T2′ added to data corresponding to the time T2.

This application is based on and claims the benefit of priority from Japanese Patent Application No. 2016-144922, filed on 22 Jul. 2016, the content of which is incorporated herein by reference.

### BACKGROUND OF THE INVENTION

### Field of the Invention

The present invention relates to a server, a method, a program, a recording medium, and a program for maintaining accuracy of time.

### Related Art

According to conventional means of measuring various physical quantities, a large number of sensors connected to a network have been arranged in large-scale systems or factories, etc. Measured quantities acquired by corresponding sensors and times of the measurement have been collected together by the server and used on condition that the collected times are in synchronization. Thus, for using measured quantities acquired by the corresponding sensors, synchronization has been required between times of data acquired by the corresponding sensors. The following inventions disclose techniques relating to a time of data.

According to an invention disclosed by Patent document 1, for synchronization between times of measurement by multiple measuring instruments in a plant, a measurement managing device in a center transmits temporal information to the measuring instruments to coincide with given timing to execute synchronization between the times of measurement by the measuring instruments, and then measured data is collected. According to the invention of Patent document 1, time synchronization is executed at the time of start of measurement and data is acquired several times. This causes a problem in that, as acquisition of data proceeds with the lapse of time, an error is increased between measuring times of acquired data.

Patent document 2 discloses a method implemented by a distributed measuring system of collecting information from a sensor terminal using a sensor network. According to this method, measuring times of corresponding sensors are synchronized by making a server correct a measuring time acquired from each sensor during measurement to a reference time of the server. According to the invention of Patent document 2, a measuring time is corrected each time measurement is started. Hence, for maintaining accuracy of time, synchronization should be executed for each acquisition of data. This means that maintaining accuracy of time necessitates time synchronization of the sensor terminal to be executed frequently. This causes a problem of imposing strain on the communication band or processing capability of the network.

Patent document 3 discloses a method implemented by a system of collecting data through a network using a wireless terminal. According to this method, for synchronization of a measuring time, a host transmits temporal information to the terminal during collection of data. The terminal corrects a time of a clock of the terminal itself to the transmitted temporal information and then transmits measured data to the host. According to the invention of Patent document 3, maintaining accuracy of time also requires transmission of temporal information from the host to the terminal for each acquisition of data, and correction of a time of the clock of the terminal itself to the transmitted temporal information by the terminal. This means that maintaining accuracy of time requires the host to transmit temporal information to the terminal frequently. This causes a problem of imposing strain on the communication band or processing capability of the network.
Patent Document 1: Japanese Unexamined Patent Application, Publication No. 2015-162108
Patent Document 2: Japanese Patent No. 4926752
Patent Document 3: Japanese Patent No. 5081874

### SUMMARY OF THE INVENTION

As described above, according to the conventional techniques, even if time synchronization is executed, a clock deviation of each sensor has caused a shift between a server time and a sensor time and this shift has increased gradually. Hence, a time of each sensor has been required to be synchronized frequently for maintaining accuracy of time. This has imposed strain on the communication band or processing capability of a network, making it impossible to measure data continuously at high speed.

An example of such a problem is shown in FIG. 8. A network is configured by connecting a large number of sensors to a server 510. Each sensor includes a clock unit. The sensor transmits data acquired in a given cycle by the sensor to the server together with temporal information determined based on the clock unit of the sensor. Two sensors illustrated in FIG. 8 will be described as examples. The server 510 includes a clock unit 515. A sensor 520 includes a clock unit 525. A sensor 530 includes a clock unit 535. The clock unit 515 of the server 510, the clock unit 525 of the sensor 520, and the clock unit 535 of the sensor 530 are to be synchronized with each other at a time T1. The clock unit 515 of the server 510 and the clock unit 525 of the sensor 520 do not have the same clock signal cycle. Hence, if sensor times Tₐ₁, Tₐ₂, . . . , Tₐₙ are added to data Dₐ₁, Dₐ₂, . . . , Dₐₙ respectively sensed with the lapse of time by the sensor 520, a deviation is caused between each of these sensor times and a corresponding one of server times Tₛ₁, Tₛ₂, . . . , Tₛₙ. The deviation between these times is increased with the lapse of time. The clock unit 515 of the server 510 and the clock unit 535 of the sensor 530 do not have the same clock signal cycle either. Hence, if sensor times T_{b1}, T_{b2}, . . . , T_{bn} are added to data D_{b1}, D_{b2}, . . . , D_{bn} respectively sensed with the lapse of time by the sensor 530, a deviation is caused between each of these sensor times and a corresponding one of the server times Tₛ₁, Tₛ₂, . . . , Tₛₙ. The deviation between these times is increased with the lapse of time. As described above, a deviation between each server time and a time of each sensor is increased with the lapse of time. Meanwhile, a deviation between a server time and a sensor time differs between sensors. Hence, a deviation is increased with time not only between a server time and a sensor time but also between sensor times of corresponding sensors. To maintain accuracy of time by reducing a deviation between a server time and times of a large number of sensors, time synchronization of the sensors has been required to be executed frequently in such a manner that all the sensors are synchronized to conform to a sensor to cause a large deviation, for example. This, however, causes a problem of imposing strain on the communication band or processing capability of the network, making it impossible to measure data continuously at high speed.

The present invention is intended to provide a server, a method, a program, a recording medium, and a system for maintaining accuracy of time of data collected from a sensor without increasing the frequency of processing of time synchronization between the server and the sensor.

(1) A server (server 11 described later, for example) collects data and temporal data about an electronic device (sensor 15 described later, for example) corresponding to the collected data together at regular intervals from the electronic device and corrects the temporal data about the electronic device corresponding to the collected data. The server comprises: a synchronizing unit (synchronizing unit 22 described later, for example) that executes synchronization processing on the electronic device at a server time T1 for synchronization between a time of the server and a time of the electronic device and executes synchronization processing on the electronic device at a server time T2 for synchronization between a time of the server and a time of the electronic device, the server time T2 being a time when a predetermined time interval comes to an end; a collecting unit (collecting unit 23 described later, for example) that collects multiple (n) data segments and temporal data segments about the electronic device corresponding to the collected data segments together acquired from the electronic device in a period from the synchronization processing at the server time T1 to the synchronization processing at the server time T2; and a correcting unit (correcting unit 24 described later, for example) that corrects the temporal data segments corresponding to the n data segments based on a synchronization shift amount that is a time difference between the server time T2 and temporal data T2′ about the electronic device corresponding to the server time T2.

(2) In the server according to (1), if the synchronization shift amount during synchronization processing exceeds a first threshold, a time interval before subsequent synchronization processing may be reduced.

(3) In the server according to (1) or (2), if the synchronization shift amount during synchronization processing is smaller than a second threshold, a time interval before subsequent synchronization processing may be increased.

(4) In the server according to (1), if the synchronization shift amount during synchronization processing fluctuates, a time interval before subsequent synchronization processing may be reduced.

(5) In the server according to (1) or (4), if the synchronization shift amount during synchronization processing does not fluctuate, a time interval before subsequent synchronization processing may be increased.

(6) A method according to the present invention is a method implemented by a server (server 11 described later, for example) that collects data and temporal data about an electronic device (sensor 15 described later, for example) corresponding to the collected data together at regular intervals from the electronic device and corrects the temporal data about the electronic device corresponding to the collected data. The method comprises: a synchronizing step of executing synchronization processing on the electronic device at a server time T1 for synchronization between a time of the server and a time of the electronic device and executing synchronization processing on the electronic device at a time T2 of the server for synchronization with a time of the electronic device based on the server time T2, the server time T2 being a time when a predetermined time interval comes to an end; a collecting step of collecting multiple (n) data segments and temporal data segments about the electronic device corresponding to the collected data segments together acquired by the electronic device in a period from the synchronization processing at the server time T1 to the synchronization processing at the server time T2; and a correcting step of correcting the temporal data segments corresponding to the n data segments based on a synchronization shift amount that is a time difference between the server time T2 and temporal data T2′ about the electronic device corresponding to the server time T2.

(7) A program according to the present invention is a program that causes a computer to function as a server (server 11 described later, for example) that collects data and temporal data about an electronic device (sensor 15 described later, for example) corresponding to the collected data together at regular intervals from the electronic device and corrects the temporal data about the electronic device corresponding to the collected data. Execution of the program on the computer causes the computer to execute: synchronization processing on the electronic device at a server time T1 for synchronization between a time of the server and a time of the electronic device and synchronization processing on the electronic device at a time T2 of the server for synchronization with a time of the electronic device based on the time T2 of the server, the server time T2 being a time when a predetermined time interval comes to an end; collection processing of collecting multiple (n) data segments and temporal data segments about the electronic device corresponding to the collected data segments together acquired by the electronic device in a period from the synchronization processing at the server time T1 to the synchronization processing at the server time T2; and correction processing of correcting the temporal data segments corresponding to the n data segments based on a synchronization shift amount that is a time difference between the server time T2 and temporal data T2′ about the electronic device corresponding to the server time T2.

(8) A recording medium according to the present invention stores the above-described program in a computer-readable manner.

(9) A system according to the present invention is a system that comprises an electronic device (sensor 15 described later, for example), and a server (server 11 described later, for example) that collects data and temporal data about the electronic device corresponding to the collected data together at regular intervals from the electronic device and corrects the temporal data about the electronic device corresponding to the collected data. The server comprises: a synchronizing unit (synchronizing unit 22 described later, for example) that executes synchronization processing on the electronic device at a server time T1 for synchronization between a time of the server and a time of the electronic device and executes synchronization processing on the electronic device at a server time T2 for synchronization between a time of the server and a time of the electronic device, the server time T2 being a time when a predetermined time interval comes to an end; a collecting unit (collecting unit 23 described later, for example) that collects multiple (n) data segments and temporal data segments about the electronic device corresponding to the collected data segments together acquired by the electronic device in a period from the synchronization processing at the server time T1 to the synchronization processing at the server time T2; and a correcting unit (correcting unit 24 described later, for example) that corrects the temporal data segments corresponding to the n data segments based on a synchronization shift amount that is a time difference between the server time T2 and temporal data T2′ about the electronic device corresponding to the server time T2. The electronic device comprises: a sensor measuring unit (sensor measuring unit 17 described later, for example) that acquires data and temporal data about the electronic device corresponding to the acquired data together in response to the synchronization processing executed at the server time T1 by the server; a sensor communicating unit (sensor communicating unit 16 described later, for example) that transmits data to the server in response to the synchronization processing executed at the server time T2 by the server, the transmitted data containing the multiple (n) data segments and the temporal data segments about the electronic device corresponding to the collected data segments acquired from the server time T1 to the server time T2, and a time T2′ of the electronic device corresponding to the server time T2; and a sensor clock unit (sensor clock unit 18 described later, for example) that synchronizes a time of the electronic device with a time of the server in response to synchronization processing executed at a time of the server by the server.

The present invention is capable of providing a server, a method, a program, a recording medium, and a system for maintaining accuracy of time of data collected from a sensor without increasing the frequency of processing of time synchronization between the server and the sensor.

### BRIEF DESCRIPTION OF THE DRAWINGS

FIG. 1 shows the configuration of a system according to an embodiment of the present invention;

FIG. 2 shows a functional block of a controller belonging to a server according to the embodiment of the present invention;

FIG. 3A shows a flow of the operation of the system according to the embodiment of the present invention;

FIG. 3B shows a flow of the operation of the system according to the embodiment of the present invention;

FIG. 4 shows a method of correcting a sensor time in the system according to the embodiment of the present invention;

FIG. 5 shows the method of correcting a sensor time used in the system according to the embodiment of the present invention;

FIG. 6 shows an example of the method of correcting a sensor time used in the system according to the embodiment of the present invention;

FIGS. 7A and 7B show an example of the method of correcting a sensor time used in the system according to the embodiment of the present invention; and

FIG. 8 shows a synchronization method used in a conventional sensor network.

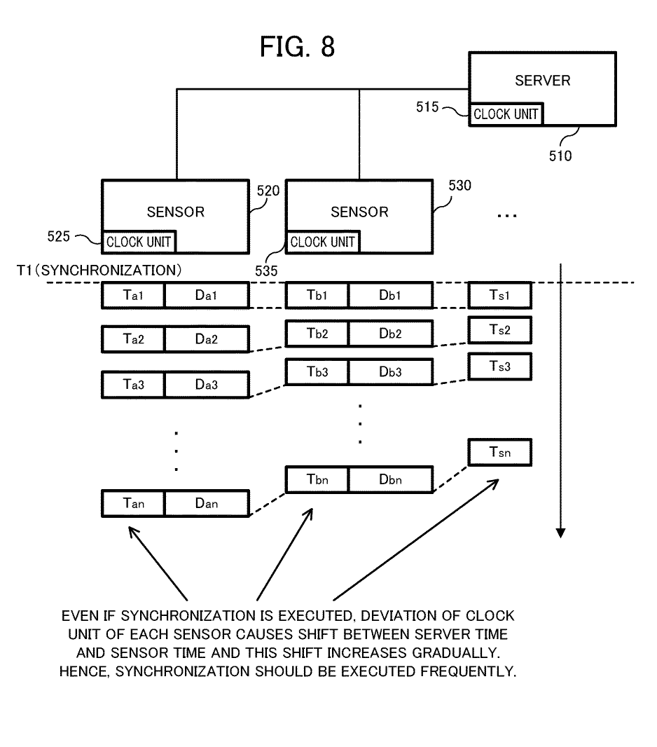

### DETAILED DESCRIPTION OF THE INVENTION

### 1. First Embodiment

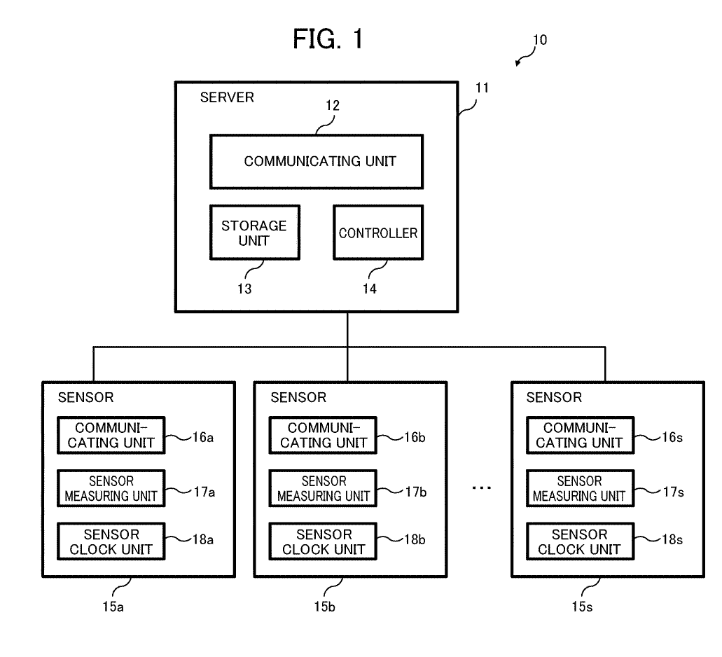

A first embodiment of the present invention will be described in detail by referring to FIGS. 1 to 7B.

### <1.1 Configuration of Invention>

FIG. 1 shows the configuration of a system according to the first embodiment of the present invention. A system 10 includes a server 11 and one or more sensors 15a, 15b, . . . , 15s (these sensors are collectively called a “sensor 15”). The server 11 and the sensor 15 are capable of communicating with each other.

### <Server>

As shown in FIG. 1, the server 11 includes a communicating unit 12 capable of communicating with the sensor 15, a storage unit 13 storing various types of data, and a controller 14 for execution of processing on various types of data, etc.

As will be described later, the communicating unit 12 is a communication interface used for transmitting a measurement start instruction, a measurement stop instruction, and a time synchronization instruction from the server 11 to the sensor 15, and for receiving sampling data containing temporal data from the sensor 15.

The storage unit 13 stores sampling data transmitted from the sensor 15, data resulting from processing on the transmitted sampling data by the controller 14, etc.

The controller 14 includes a CPU, a ROM, a RAM, a CMOS memory, etc. These are configured to be capable of communicating with each other through a bus and publicly-known constituting elements for the person skilled in the art.

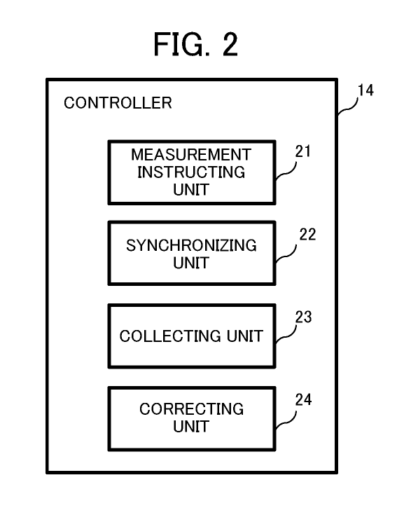

The CPU is a processor that controls the server 11 entirely. The CPU is configured to make the controller 14 achieve the functions of a measurement instructing unit 21, a synchronizing unit 22, a collecting unit 23, and a correcting unit 24 shown in FIG. 2 by reading a system program and an application program from the ROM through the bus and controlling the server 11 entirely according to the read system program and application program. FIG. 2 shows a functional block of the controller 14. The RAM stores various types of data such as temporal calculation data and display data. The CMOS memory is backed up by a battery not shown in the drawings. The CMOS memory is configured to function as a nonvolatile memory that maintains its storage state even if the server 11 is powered off.

The measurement instructing unit 21 generates a measurement start instruction directed to the sensor 15 to measure a certain physical quantity in a given cycle and to start acquiring sampling data containing the measured quantity acquired by the sensor 15 and a time of the measurement. The measurement instructing unit 21 transmits the generated measurement start instruction to the sensor 15 through the communicating unit 12. The measurement instructing unit 21 generates a measurement stop instruction directed to the sensor 15 to stop acquisition of sampling data. The measurement instructing unit 21 transmits the generated measurement stop instruction to the sensor 15 through the communicating unit 12.

The synchronizing unit 22 acquires a server time from a clock unit of the server 11 (not shown in the drawings), generates a time synchronization instruction containing the server time, and transmits the generated time synchronization instruction to the sensor 15 through the communicating unit 12. The synchronizing unit 22 generates a time synchronization instruction to coincide with the following timing. The synchronizing unit 22 generates and transmits a time synchronization instruction when the measurement instructing unit 21 transmits a measurement start instruction to the sensor 15. This allows the sensor 15 to synchronize a sensor time with a server time at the time of start of measurement. Next, when a synchronization time interval set for each sensor 15 comes to an end after transmission of the time synchronization instruction, the synchronizing unit 22 acquires a server time from the clock unit, generates a time synchronization instruction containing the acquired server time, and transmits the generated time synchronization instruction to the sensor 15. Finally, when the measurement instructing unit 21 transmits a measurement stop instruction to the sensor 15, the synchronizing unit 22 generates and transmits a time synchronization instruction. This allows the sensor 15 to synchronize a sensor time with a server time at the time of stop of measurement. Regarding the synchronization time interval set for each sensor 15, an initial value is set and stored first in the storage unit 13. Then, the synchronization time interval is changed by the correcting unit 24 described later.

The collecting unit 23 collects sampling data sensed by the sensor 15 and temporal data about the sensing together from the sensor 15 through the communicating unit 12. More specifically, the collecting unit 23 collects multiple sampling data segments containing measuring times from the sensor 15 through the communicating unit 12. These sampling data segments are transmitted from the sensor 15 in response to transmission of a time synchronization instruction from the synchronizing unit 22 to the sensor 15 and are measured by the sensor 15 in a given cycle between the transmitted time synchronization instruction and a time synchronization instruction issued most recently. More specifically, if the synchronizing unit 22 synchronizes a time with the sensor 15 at a server time T1 and synchronizes a time with the sensor 15 at a server time T2, the collecting unit 23 collects the following from the sensor 15: n measured data segments acquired by the sensor 15 from the server time T1 to the server time T2; sensor times when these measured data segments are acquired; the server time T1; the server time T2; and a time T2′ of the sensor 15 corresponding to the server time T2. Unless otherwise specified, for the sake of simplification, data containing n measured data segments acquired by the sensor 15 from the server time T1 to the server time T2, sensor times when these measured data segments are acquired, the server time T1, the server time T2, and the time T2′ of the sensor 15 corresponding to the server time T2 will also be called sampling data. The collecting unit 23 collects sampling data sensed by the sensor 15 after a time synchronization instruction is transmitted subsequently to an initial time synchronization instruction transmitted at the time of transmission of a measurement start instruction.

The correcting unit 24 corrects temporal data contained in sampling data collected from the sensor 15.

### <Correction of Temporal Data>

More specifically, based on sampling data collected by the collecting unit 23 from the sensor 15 (specifically, data containing n measured data segments acquired from the server time T1 to the server time T2, sensor times when these measured data segments are acquired, the server time T1, the server time T2, and the time T2′ of the sensor 15 corresponding to the server time T2) and by using a synchronization shift amount (T2′−T2) that is a time difference between the server time T2 and temporal data T2′ added to data corresponding to the server time T2, the correcting unit 24 corrects each temporal data tᵢ′ (where i is in a range from 1 to n) added to a corresponding one of the n data segments to a server time. This correction is made by linear conversion so as to make T2′ agree with the server time T2 while the server time T1 of synchronization is fixed. This allows the server 11 to maintain accuracy of a time of measurement of sensed data acquired by the sensor 15 between two synchronization times (server time T1 and server time T2).

### <First Correction of Synchronization Time Interval>

The correcting unit 24 can be configured to correct a synchronization time interval set for each sensor 15 based on sampling data collected from the sensor 15. More specifically, if a synchronization shift amount (T2′−T2) calculated based on the sampling data collected from the sensor 15 exceeds a predetermined first threshold, the correcting unit 24 corrects a synchronization time interval by reducing the same, thereby reducing an interval before subsequent synchronization processing. This allows the server 11 to increase accuracy of a time of measurement of sensed data acquired by the sensor 15.

### <Second Correction of Synchronization Time Interval>

The correcting unit 24 can be configured to correct a synchronization time interval set for each sensor 15 based on a difference between a last synchronization shift amount and a last but one synchronization shift amount. More specifically, if a difference between the last synchronization shift amount and the last but one synchronization shift amount exceeds a predetermined third threshold, the correcting unit 24 corrects a synchronization time interval by reducing the same, thereby reducing an interval before subsequent synchronization processing. By doing so, if a shift between the clock of the server 11 and that of the sensor 15 does not have a linear shape, a synchronization time interval is reduced. In this way, the shift between the clock of the server 11 and that of the sensor 15 is corrected to approximate to a linear shape. This allows the server 11 to increase accuracy of a time of measurement of sensed data acquired by the sensor 15.

By following the aforementioned procedure, the system 10 is allowed to adjust a synchronization time interval for each sensor 15 in a manner that depends on the characteristics of a time shift of each sensor 15. Thus, accuracy of time of data can be maintained without the need of synchronizing all sensors so as to conform to a sensor to cause a large deviation, specifically, without the need of increasing the frequency of synchronization processing, for example. This makes it possible to reduce a load on the server 11 and reduce strain to be imposed on the communication band or processing capability of a network, so that data can be collected continuously at high speed from the sensor 15.

### <Sensor>

As shown in FIG. 1, the sensor 15a includes a communicating unit 16a, a sensor measuring unit 17a, and a sensor clock unit 18a. Specifically, the sensor 15 includes a communicating unit 16, a sensor measuring unit 17, a sensor clock unit 18. In a system of managing the operating states of a large number of machine tools installed on a factory using a server, for example, the server is required to collect the following together from each machine tool together at regular intervals: a parameter of a machining program, a motor instruction speed during the machining, motor current information, measured values from various sensors installed on each machine tool, etc., and times of measurement of these values. Thus, the sensor installed on the machine tool can be said to include a communicating unit, a sensor measuring unit, and a sensor clock unit. If a sensor and a communicating unit are installed on a thing such as an industrial machine in the field of the Internet of things (IoT), the sensor can also be said to include a communicating unit, a sensor measuring unit, and a sensor clock unit. As described above, the sensor 15 according to the first embodiment can be said to be a constituting element of a machine tool or in the field of the IoT.

The communicating unit 16 is a communication interface used for receiving a measurement start instruction, a measurement stop instruction, and a time synchronization instruction from the server 11, and for transmitting sampling data containing temporal data from the sensor 15.

If a measurement start instruction is received from the server 11, the sensor measuring unit 17 starts measuring a certain physical quantity in a given cycle and starts acquiring sampling data containing the measured quantity acquired by the sensor 15 and a time of the measurement. The sensor measuring unit 17 continues acquiring sampling data until a measurement stop instruction is received from the server 11. The sensor measuring unit 17 transmits the following data to the server 11 through the communicating unit 16 in a period from when time synchronization is executed in response to a time synchronization instruction from the server (server time T1) to when time synchronization is executed in response to a subsequent time synchronization instruction from the server 11 (server time T2): data containing n measured data segments acquired from the server time T1 to the server time T2; sensor times when these measured data segments are acquired; the server time T1; the server time T2; and the time T2′ of the sensor 15 corresponding to the server time T2.

If a time synchronization instruction containing a server time is received from the server 11, the sensor clock unit 18 executes processing of time synchronization between the sensor 15 and the server 11. More specifically, the sensor clock unit 18 synchronizes a sensor time of the sensor 15 with the received server time. The sensor clock unit 18 stores synchronization information containing a sensor time before execution of synchronization and a sensor time resulting from the synchronization into a sensor storage unit (not shown in the drawings). By following the aforementioned procedure, if a time synchronization instruction containing a server time is received from the server 11 at each of the server time T1 and the server time T2, the sensor measuring unit 17 can generate data containing n measured data segments acquired from the server time T1 to the server time T2, n sensor times when these measured data segments are acquired, the server time T1, and synchronization information (the server time T2 and the time T2′ of the sensor 15 corresponding to the server time T2). The function of the server 11 and that of the sensor 15 are those described above.

<1.2 Description of Operation>

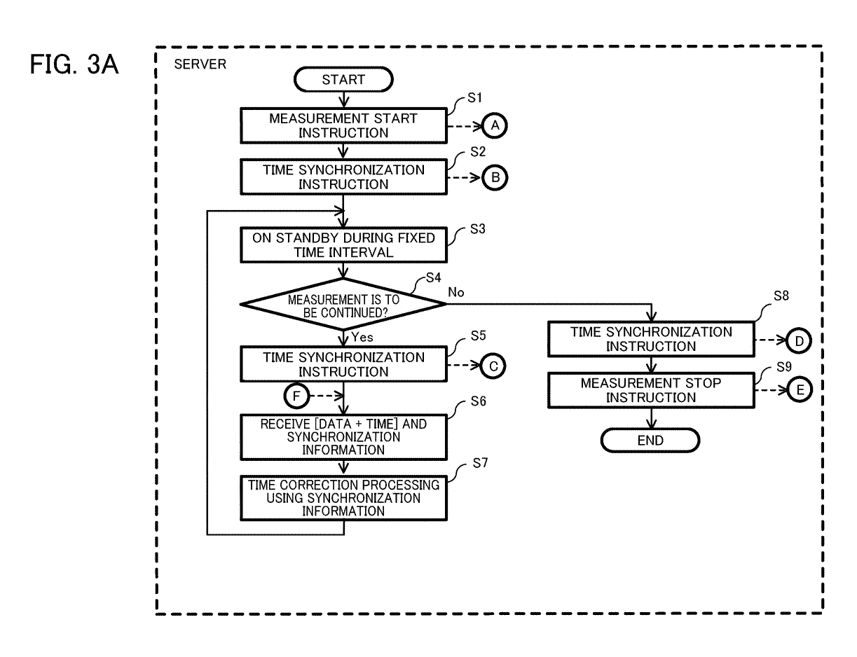

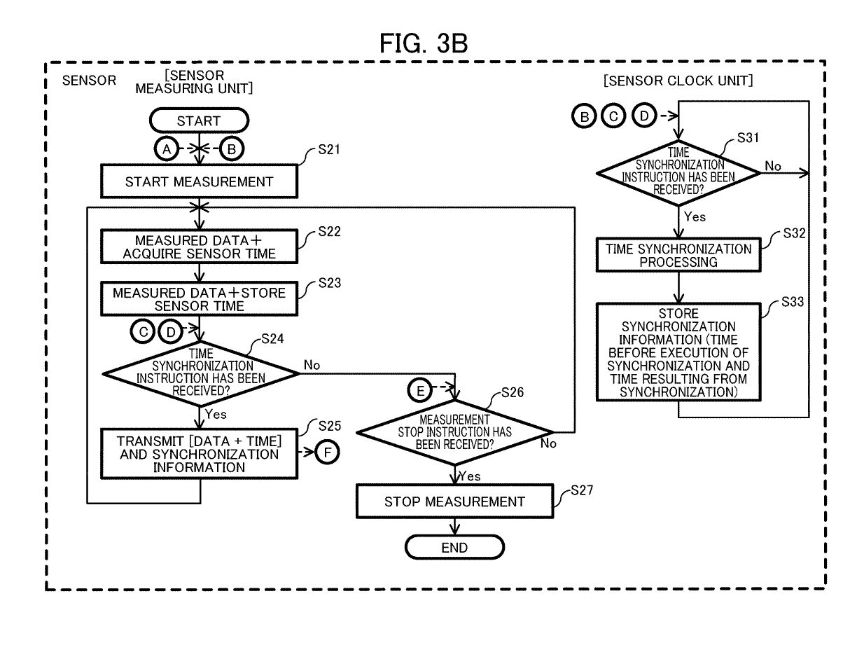

A flow of the operation of the system 10 will be described next by referring to FIGS. 3A and 3B. FIGS. 3A and 3B each show a flow of the operation of the system 10.

A flow of the operation of the server 11 will be described first in detail using FIG. 3A.

In step S1, the measurement instructing unit 21 of the server 11 transmits a measurement start instruction to the sensor 15.

In step S2, the synchronizing unit 22 of the server 11 transmits a time synchronization instruction accompanying start of measurement to the sensor 15.

In step S3, the server 11 is placed on standby during a synchronization time interval set for each sensor 15.

In step S4, if the measurement is to be continued by the server 11 (step S4: Yes), the processing shifts to step S5. If the measurement is not to be continued by the server 11 (step S4: No), the processing shifts to step S8.

In step S5, the synchronizing unit 22 of the server 11 transmits a time synchronization instruction to the sensor 15.

In step S6, the server 11 receives sampling data containing sensor temporal data and synchronization information from the sensor 15.

In step S7, the correcting unit 24 of the server 11 corrects the sensor temporal data contained in the sampling data using the synchronization information received from the sensor 15. Then, the processing shifts to step S3.

In step S8, the synchronizing unit 22 of the server 11 transmits a time synchronization instruction accompanying stop of the measurement to the sensor 15.

In step S9, the measurement instructing unit 21 of the server 11 transmits a measurement stop instruction to the sensor 15.

A flow of the operation of the sensor 15 will be described next in detail using FIG. 3B. The following description of the operation of the sensor 15 includes the following descriptions given separately: description of a flow of the operation of the sensor measuring unit 17 of the sensor 15; and that of a flow of the operation of the sensor clock unit 18. The flow of the operation of the sensor measuring unit 17 will be described first.

In step S21, the sensor 15 (sensor measuring unit 17) receives a measurement start instruction and a time synchronization instruction accompanying start of measurement from the server 11. Then, the sensor measuring unit 17 starts the measurement.

In step S22, the sensor measuring unit 17 acquires measured data containing sensor temporal data.

In step S23, the sensor measuring unit 17 stores the measured data containing the sensor temporal data into the sensor storage unit (not shown in the drawings).

In step S24, the sensor measuring unit 17 determines whether or not a time synchronization instruction has been received from the server 11. If a time synchronization instruction has been received (step S24: Yes), the processing shifts to step S25. If a time synchronization instruction has not been received (step S24: No), the processing shifts to step S26.

In step S25, the sensor measuring unit 17 transmits sampling data containing the sensor temporal data and synchronization information to the server 11. Then, the processing returns to step S22.

In step S26, the sensor measuring unit 17 determines whether or not a measurement stop instruction has been received from the server 11. If the sensor measuring unit 17 has received a measurement stop instruction (step S26: Yes), the processing shifts to step S27. If the sensor measuring unit 17 has not received a measurement stop instruction (step S26: No), the processing returns to step S22.

In step S27, the sensor measuring unit 17 stops the measurement.

The flow of the operation of the sensor clock unit 18 of the sensor 15 will be described next.

In step S31, the sensor clock unit 18 determines whether or not the sensor 15 has received a time synchronization instruction from the server 11. If the sensor 15 has received a time synchronization instruction from the server 11 (step S31: Yes), the processing shifts to step S32. If the sensor 15 has not received a time synchronization instruction from the server 11 (step S31: No), the processing returns to step S31.

In step S32, the sensor clock unit 18 executes processing of time synchronization between the sensor 15 and the server 11.

In step S33, the sensor clock unit 18 stores synchronization information containing a sensor time before execution of synchronization and a sensor time resulting from the synchronization into the sensor storage unit (not shown in the drawings). Then, the processing returns to step S31.

The flow of the operation of the system 10 is as described above.

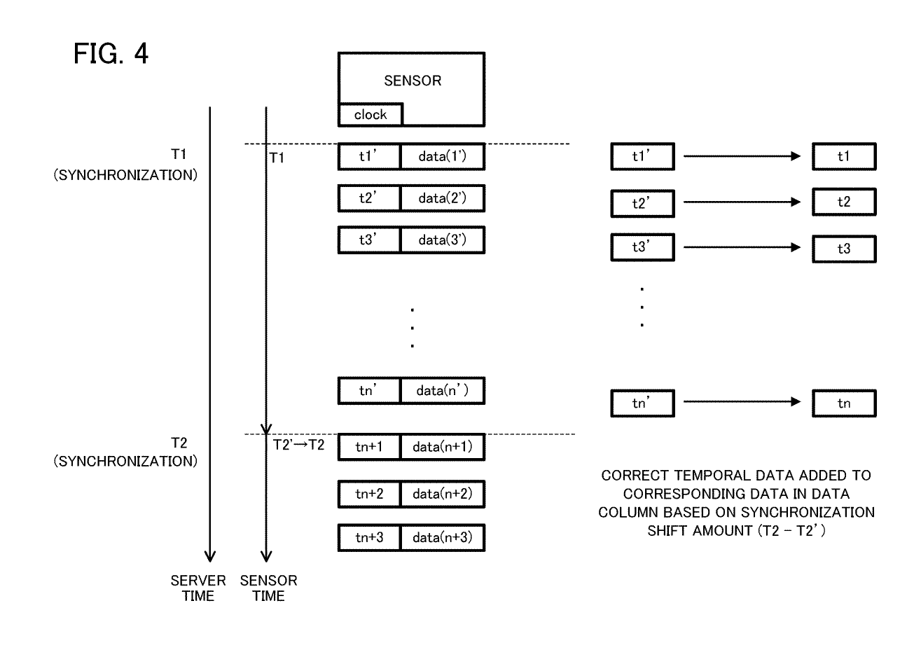

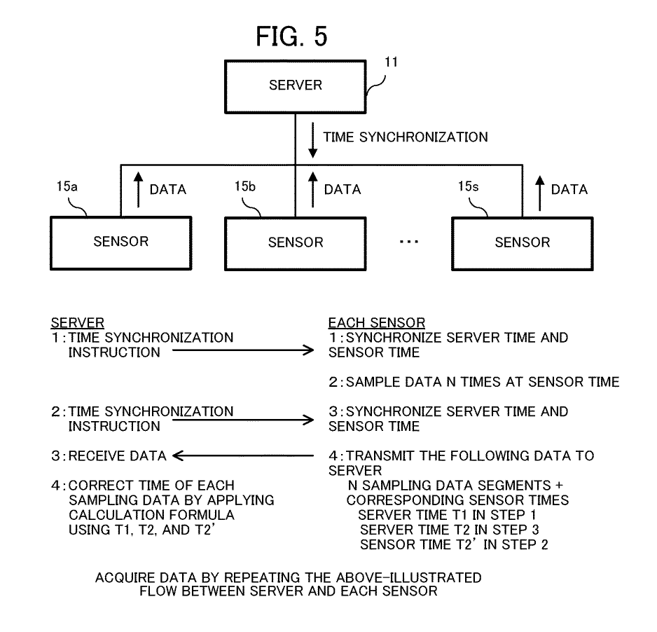

As described above by referring to step S7 of FIG. 3A, the correcting unit 24 of the server 11 corrects sensor temporal information contained in sampling data using synchronization information containing a sensor time before execution of synchronization on the sensor 15 and a sensor time resulting from the synchronization. FIGS. 4 and 5 briefly show processing of this correction.

As shown in FIG. 4, processing of synchronization is to be executed between the server 11 and the sensor 15 at the server time T1. Further, the synchronization processing is to be executed to synchronize the server time T2 and the sensor time T2′, thereby correcting the sensor time T2′ to T2. For this synchronization processing, the sensor 15 samples n data segments including data (1′), data (2′), . . . , data (n′) from a sensor time T1 to the sensor time T2′. To correct sensor times t1′, t2′, . . . , tn′ added to corresponding ones of these sampled n data segments to t1, t2, . . . , tn respectively, a synchronization shift amount (T2−T2′) is used in the correction processing executed in step S7 of FIG. 3A.

According to the present invention, the server 11 does not execute synchronization simultaneously with all the sensors 15. As shown in FIG. 5, the server 11 transmits a time synchronization instruction to each sensor 15. Then, sampling data containing a sensor time is transmitted from each sensor 15 to the server 11 and this sensor time is corrected by the server 11.

More specifically, as illustrated in FIG. 5, a time synchronization instruction is transmitted from the server 11 to the sensor 15 at the server time T1 to synchronize the server 11 and each sensor 15. Next, when a synchronization time interval set for each sensor 15 comes to an end (server time T2), the server 11 acquires a server time from the clock unit (not shown in the drawings), and transmits a time synchronization instruction containing the acquired server time to the sensor 15. In a period from receipt of a time synchronization instruction from the server 11 (server time T1) to receipt of a subsequent time synchronization instruction from the server 11 (server time T2), the sensor 15 samples data segments N times based on a sensor time. After sampling the data segments N times, the sensor 15 receives the time synchronization instruction from the server 11 (server time T2) at the server time T2 to correct the sensor time T2′ to the server time T2. Next, the sensor 15 transmits sampling data containing N sensor times and synchronization information, specifically, the sensor 15 transmits the server times T1 and T2, and the sensor time T2′ to the server 11. Then, the server 11 corrects the sensor times contained in the sampling data based on T1, T2, and T2′. This synchronization processing accompanying the correction is executed between the server 11 and each sensor 15.

Specifically, according to the present invention, the server 11 is not required to execute processing simultaneously for synchronization with all the sensors 15. The sever 11 corrects temporal data for each sensor 15 contained in data sensed by the sensor 15.

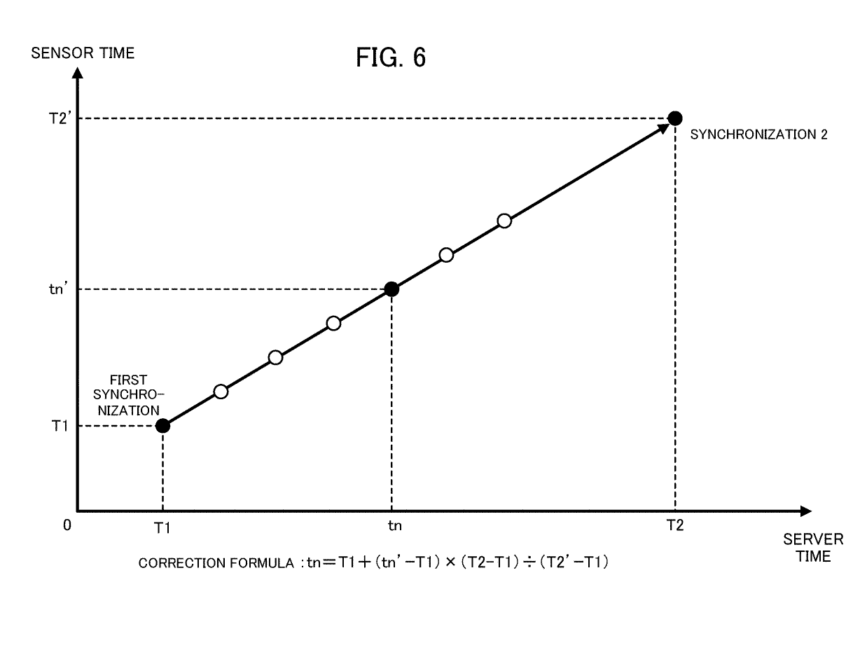

FIG. 6 briefly shows the above-described correction processing.

According to the present invention, sensor times acquired during sampling are corrected linearly to server times between one synchronization processing to subsequent synchronization processing. As understood from the graph shown in FIG. 6, this correction is to correct a sensor time tn′ (where n is in a range from 1 to N) based on a formula 1. The sensor time tn′ is a time from the sensor time T1 to the sensor time T2′ and contained in data sampled at this sensor time tn′.

tn=T1+(tn′−T1)×(T2−T1)÷(T2′−T1) (Formula 1)

Specifically, the value of tn is calculated as follows: “a distance between Y coordinate points” between a point “FIRST SYNCHRONIZATION” and a point showing sampling data is multiplied by a value obtained by “dividing a distance between X coordinate points by a distance between Y coordinate points,” both of which range between the point “FIRST SYNCHRONIZATION” and a point “SECOND SYNCHRONIZATION”. A value obtained by this multiplication is added to an X coordinate value at the point “FIRST SYNCHRONIZATION”.

As a result, synchronization processing is not required to be executed each time data is sampled. By correcting temporal data contained in each sampling data, the accuracy of this temporal data can be maintained.

The following briefly describes processing of correcting a synchronization time interval set for each sensor 15 based on the magnitude of a synchronization shift amount.

The correcting unit 24 corrects a synchronization time interval set for a sensor 15 as a target of designation of a subsequent synchronization time interval based on a synchronization shift amount.

Referring to the graph of FIG. 6, the graph slopes more gently with increase in a synchronization shift amount (T2−T2′). This unfortunately increases a correction amount (tn−tn′) of each sampling data.

Thus, if the synchronization shift amount (T2−T2′) is comparatively large, specifically, if the synchronization shift amount (T2−T2′) is larger than the predetermined first threshold during synchronization processing currently executed, a time interval before subsequent synchronization processing is reduced. By doing so, the correction amount (tn−tn′) of each sampling data can be reduced.

Meanwhile, if the synchronization shift amount (T2−T2′) is comparatively small, specifically, if the shift amount (T2−T2′) is smaller than a second threshold determined in advance to be smaller than the first threshold, the correction amount (tn−tn′) of current sampling data is determined to remain at a small value. Then, an interval before subsequent synchronization processing is increased. Thus, the frequency of synchronization processing is reduced. This makes it possible to reduce a load on the server 11 and reduce strain to be imposed on the communication band or processing capability of a network, so that data can be collected continuously at high speed from the sensor 15.

The following briefly describes processing of correcting a synchronization time interval set for each sensor 15 based on a fluctuation in a synchronization shift amount.

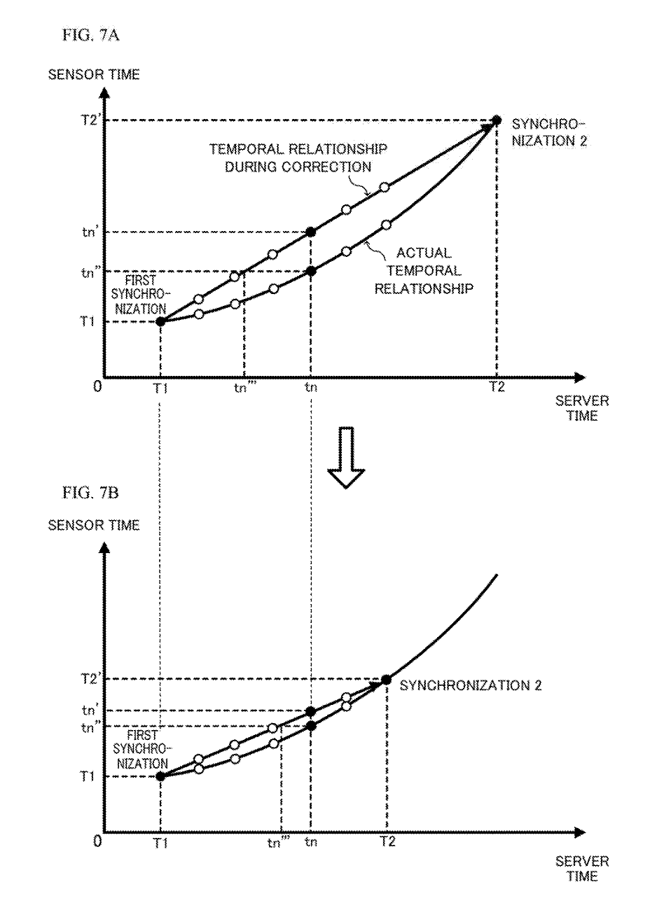

The above-described correction processing is executed based on the assumption that a shift between a server time and a sensor time takes on a linear shape. By contrast, as shown by a graph indicated by a note “ACTUAL TEMPORAL RELATIONSHIP” in FIG. 7A, a third specific example described below is a correction method employed if a shift between a server time and a sensor time does not take on a linear shape.

As shown by the graphs in FIG. 7A, if the correcting unit 24 corrects a sensor time tn′ (1<n<N) using the formula (1), the sensor time tn′ is corrected to a time tn. However, the actual temporal relationship shows that a sensor time corresponding to the server time tn is a sensor time tn“. In this way, an error is caused between the sensor time tn” and the sensor time tn′.

Then, if a synchronization shift amount during synchronization processing fluctuates, specifically, if a difference between a synchronization shift amount during last synchronization processing and a synchronization shift amount during last but one synchronization processing exceeds the predetermined third threshold, for example, the correcting unit 24 reduces a synchronization time interval (T2−T1) from the last synchronization processing to synchronization processing currently executed, as shown in FIG. 7B. By doing so, as clearly understood from comparison between the graphs in FIG. 7A and the graphs in FIG. 7B, an error between the sensor time tn″ and the sensor time tn′ can be reduced.

Conversely, if a synchronization shift amount does not fluctuate during synchronization processing, specifically, if a difference between a synchronization shift amount during last synchronization processing and a synchronization shift amount during last but one synchronization processing is smaller than a fourth threshold determined in advance to be smaller than the third threshold, the correcting unit 24 increases a synchronization time interval before subsequent synchronization processing. Thus, the frequency of synchronization processing is reduced. This makes it possible to reduce a load on the server 11 and reduce strain to be imposed on the communication band or processing capability of a network, so that data can be collected continuously at high speed from the sensor 15.

The system 10 according to the above-described first embodiment is allowed to adjust a synchronization time interval for each sensor 15 in a manner that depends on the characteristics of a time shift of each sensor 15. Thus, accuracy of time of data can be maintained without the need of synchronizing all sensors so as to conform to a sensor to cause a large deviation, specifically, without the need of increasing the frequency of synchronization processing, for example. This makes it possible to reduce a load on the server 11 and reduce strain to be imposed on the communication band or processing capability of a network, so that data can be collected continuously at high speed from the sensor 15.

According to the above-described embodiment, the synchronizing unit 22 of the server 11 generates a time synchronization instruction and transmits the generated time synchronization instruction to the sensor 15, thereby executing processing of synchronization between a time of the server 11 and a time of the sensor 15. However, this is not the only embodiment of the present invention. For example, the synchronizing unit 22 of the server 11 may not generate a time synchronization instruction. Processing of synchronization between a time of the server 11 and a time of the sensor 15 may alternatively be executed by embedding a server time in receipt acknowledgement (ACK) and transmitting the ACK to the sensor 15 in response to receipt of sampling data from this sensor 15 to the server 11. Any other method capable of notifying a time of the server 11 to the sensor 15 can be employed.

### 2. Second Embodiment

A second embodiment of the present invention will be described next.

According to the above-described first embodiment, the server 11 collects sampling data sensed by the sensor 15 and corrects temporal data contained in the collected sampling data.

The present invention may be applied to an electronic device for generation or update of data instead of the sensor 15 according to the first embodiment. For example, if the server 11 collects data generated or updated by this electronic device and temporal data about the generated or updated data together at regular intervals, the server 11 may correct the temporal information about the data collected from the electronic device in the same manner as described in the first embodiment. If a server collects data generated or updated by a client and temporal data together at regular intervals and the server executes online processing based on the collected temporal information using various online network systems, for example, the temporal information about the data collected from the client can be corrected in the same manner as described in the first embodiment.

Like the first embodiment, the second embodiment is capable of maintaining accuracy of time of generated or updated data without increasing the frequency of synchronization processing. This makes it possible to reduce a load on the server 11 and reduce strain to be imposed on the communication band or processing capability of a network, so that data can be collected continuously at high speed from the electronic device.

In the above-described first and second embodiments, the method of maintaining accuracy of time implemented by the system 10 and the server 11 is realized by software. If this method is to be realized by software, programs for configuring this software are installed on a computer (server 11). These programs may be recorded on a removable medium and then distributed to a user. Alternatively, these programs may be distributed to the user by being downloaded to a computer of the user through a network.

### EXPLANATION OF REFERENCE NUMERALS

10 System
11 Server
12 Communicating unit
13 Storage unit
14 Controller
15, 15a, 15b, 15s Sensor
16, 16a, 16b, 16s Communicating unit
17, 17a, 17b, 17s Sensor measuring unit
18, 18a, 18b, 18s Sensor clock unit
21 Measurement instructing unit
22 Synchronizing unit
23 Collecting unit
24 Correcting unit

What is claimed is:

1. A server that collects data and temporal data about an electronic device corresponding to the collected data together at regular intervals from the electronic device and corrects the temporal data about the electronic device corresponding to the collected data, the server comprising:
a synchronizing unit that executes synchronization processing on the electronic device at a server time T1 for synchronization between a time of the server and a time of the electronic device and executes synchronization processing on the electronic device at a server time T2 for synchronization between a time of the server and a time of the electronic device, the server time T2 being a time when a predetermined time interval comes to an end;
a collecting unit that collects multiple (n) data segments and temporal data segments about the electronic device corresponding to the collected data segments together acquired by the electronic device in a period from the synchronization processing at the server time T1 to the synchronization processing at the server time T2; and
a correcting unit that corrects the temporal data segments corresponding to the n data segments based on a synchronization shift amount that is a time difference between the server time T2 and temporal data T2′ about the electronic device corresponding to the server time T2.

2. The server according to claim 1, wherein if the synchronization shift amount during synchronization processing exceeds a first threshold, a time interval before subsequent synchronization processing is reduced.

3. The server according to claim 1, wherein if the synchronization shift amount during synchronization processing is smaller than a second threshold, a time interval before subsequent synchronization processing is increased.

4. The server according to claim 1, wherein if the synchronization shift amount during synchronization processing fluctuates, a time interval before subsequent synchronization processing is reduced.

5. The server according to claim 1, wherein if the synchronization shift amount during synchronization processing does not fluctuate, a time interval before subsequent synchronization processing is increased.

6. A method implemented by a server that collects data and temporal data about an electronic device corresponding to the collected data together at regular intervals from the electronic device and corrects the temporal data about the electronic device corresponding to the collected data, the method comprising:
a synchronizing step of executing synchronization processing on the electronic device at a server time T1 for synchronization between a time of the server and a time of the electronic device and executing synchronization processing on the electronic device at a time T2 of the server for synchronization with a time of the electronic device based on the server time T2, the server time T2 being a time when a predetermined time interval comes to an end;
a collecting step of collecting multiple (n) data segments and temporal data segments about the electronic device corresponding to the collected data segments together acquired by the electronic device in a period from the synchronization processing at the server time T1 to the synchronization processing at the server time T2; and
a correcting step of correcting the temporal data segments corresponding to the n data segments based on a synchronization shift amount that is a time difference between the server time T2 and temporal data T2′ about the electronic device corresponding to the server time T2.

7. A recording medium storing a program in a computer-readable manner, the program causing a computer to function as a server that collects data and temporal data about an electronic device corresponding to the collected data together at regular intervals from the electronic device and corrects the temporal data about the electronic device corresponding to the collected data, execution of the program on the computer causing the computer to execute:
synchronization processing on the electronic device at a server time T1 for synchronization between a time of the server and a time of the electronic device and synchronization processing on the electronic device at a time T2 of the server for synchronization with a time of the electronic device based on the time T2 of the server, the server time T2 being a time when a predetermined time interval comes to an end;
collection processing of collecting multiple (n) data segments and temporal data segments about the electronic device corresponding to the collected data segments together acquired by the electronic device in a period from the synchronization processing at the server time T1 to the synchronization processing at the server time T2; and
correction processing of correcting the temporal data segments corresponding to the n data segments based on a synchronization shift amount that is a time difference between the server time T2 and temporal data T2′ about the electronic device corresponding to the server time T2.

8. A system comprising an electronic device, and a server that collects data and temporal data about the electronic device corresponding to the collected data together at regular intervals from the electronic device and corrects the temporal data about the electronic device corresponding to the collected data,
the server comprising:
a synchronizing unit that executes synchronization processing on the electronic device at a server time T1 for synchronization between a time of the server and a time of the electronic device and executes synchronization processing on the electronic device at a server time T2 for synchronization between a time of the server and a time of the electronic device, the server time T2 being a time when a predetermined time interval comes to an end;
a collecting unit that collects multiple (n) data segments and temporal data segments about the electronic device corresponding to the collected data segments together acquired by the electronic device in a period from the synchronization processing at the server time T1 to the synchronization processing at the server time T2; and
a correcting unit that corrects the temporal data segments corresponding to the n data segments based on a synchronization shift amount that is a time difference between the server time T2 and temporal data T2′ about the electronic device corresponding to the server time T2,
the electronic device comprising:
a sensor measuring unit that acquires data and temporal data about the electronic device corresponding to the acquired data together in response to the synchronization processing executed at the server time T1 by the server;
a sensor communicating unit that transmits data to the server in response to the synchronization processing executed at the server time T2 by the server, the transmitted data containing the multiple (n) data segments and the temporal data segments about the electronic device corresponding to the collected data segments acquired from the server time T1 to the server time T2, and a time T2′ of the electronic device corresponding to the server time T2; and
a sensor clock unit that synchronizes a time of the electronic device with a time of the server in response to synchronization processing executed at a time of the server by the server.
